(19) United States
(12) Patent Application Publication
(10) Pub. No.: US 2007/0150969 A1
(43) Pub. Date: Jun. 28, 2007

(54) Method For Producing An Anti-Theft/Anti-Copy Optical Medium

(76) Inventor: Richard H. Selinfreund, Terre Haute, IN (US)

Correspondence Address: KELLEY DRYE & WARREN LLP, 400 ATLANTIC STREET, 13TH FLOOR, STAMFORD, CT, 06901, US

(21) Appl. No.: 11/539,868

(22) Filed: Oct. 9, 2006

Related U.S. Application Data
(60) Provisional application No. 60/726,048, filed on Oct. 12, 2005.

(51) Int. Cl. G06F 11/00

(52) U.S. Cl. 726/35

(57) ABSTRACT

A method for producing a theft-protected optical medium printing onto a portion an optical medium state change material having at least a first unactivated state and a second activated state, said portion of said optical medium and said state change material selected to cause content on said optical medium to be unreadable by an optical reader when said state change material is in an unactivated state, but to be readable by said optical reader when said state change material is in an unactivated state.

### RELATED APPLICATIONS

This application claims priority to U.S. Provisional Patent Application No. 60/726,048 filed Oct. 12, 2005. The disclosure of each such application is hereby incorporated by reference in its entirety where appropriate for teachings of additional or alternative details, features, and/or technical background, and priority is asserted from each.

### BACKGROUND OF THE INVENTION

1. Field of the Invention

The present invention generally relates to a method for applying materials to an recording medium in a manner to protect the medium from illicit copying and theft.

2. Description of the Related Art

The development of software and other forms of content data, such as visual and auditory digital data, represents a large investment in time and money, Such content data is often stored in digital form on a transportable storage medium which is then sold to a purchaser. Unfortunately, with most traditional transportable digital recording media, clandestine movement from of the recording medium from its intended distribution path is relatively easy, extraction of the data from the transportable storage media is possible along its distribution chain is relatively easy and the production of illicit copies of copyrighted material stored on the recording medium is relatively simplistic even for the relatively uninitiated in computer science.

To offset the costs of shoplifting of transportable recording medium, retailers pass on losses to consumers in the form of higher retail prices. To offset the losses occurring in the distribution chain, and in illicit copying of information stored on the transportable recording medium, purveyors charge hi-her prices to retailers. In the end, consumers pay considerably higher prices for recording medium due to such illicit activities.

There have been numerous attempts to curb content data piracy on transportable digital recording media. In one approach, a serial number is placed in the content data to allow for tracing of unauthorized copies of the serialized content data. The problem with this method is that it requires the task of external enforcement to track down illegal copies and is of relatively little use when the item is not associable with a particular person. Further, hackers of a number of such systems have found it relatively easy to locate and erase the serial numbers.

To deter shoplifting and distribution chain theft, some entities employ electronic article surveillance (EAS) systems that include transponder tags (RFID, etc.) attached to each article of merchandise. With respect to transportable digital recording media, such transponder tags are typically associated with the packaging surrounding the media. EAS systems further include one or more electronic readers positioned at exits to detect the transponder tags. When an item is purchased, or is removed from the distribution chain in an authorized manner, the transponder tag is disabled or removed from the article and the merchandise may pass by the reader without sounding an alarm. When a person attempts to remove an article without authorization, the reader detects the transponder tag that has not been disabled or removed from the article and sounds the alarm.

As transportable digital recording media is often small and easily concealed, EAS systems are easily overcome by simply removing the desired recording medium from its packaging, concealing the medium and then concealingly removing the medium. After the media is removed, the data thereon can generally be copied easily. Placing RFID directly on the digital recording medium has been ruled out for several reasons, including the cost of the recording medium, the difficulty in placing the RFID in a manner to provide a read through a package, and the radio frequencies employed by such systems not being approved for in-flight use.

Theft may also occur when the purveyor of merchandise allows customers or distributors to freely return merchandise even in the absence of proof of purchase, if the merchandise being returned is carried by the sales outlet. Some persons purchase merchandise at reduced sale prices, or pilfer such merchandise, and then return the merchandise to the same or another purveyor for exchange or refund, claiming to have paid full price for the merchandise. In respect of digital recording media, a request for a refund may come after the content of the digital recording medium has been downloaded. If the purveyor refunds the full price, the purveyor loses the amount in excess of the purchase price in addition to the cost of processing the returned merchandise.

There is a need for improved anti-theft/anti-copy recording medium, in recording medium, and a method for fabricating the same.

### DEFINITIONS

“Digital Datum Indicia”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a digital data read.

“Digital Reader”: any device capable of detecting and reading digital information that has been recorded on an Digital Recording Medium. By the term “reader” it is meant to include, without limitation, a player. Examples are CD and DVD readers.

“Digital Recording Medium”: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. Information stored on the medium may include, without limitation, software programs, software data, sensory files, audio files and video files.

“Light-Activated State-Change Material”: a State-Change Material that alters a measurable state function upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader (as defined below) for the reading of Optical Medium.

“Permanent State-Change Material”: a State-Change Material that once activated to change a measurable state function upon application of energy to the material, stays in such state permanently or for a prolonged period of time.

“State-Change Material”: a material capable of altering a measurable property of the material upon activation of the material by application of energy to the material. By “state change material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure, materials that shrink upon application of heat) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material spontaneously in a short period of time (minutes or less), loses such change in the measurable property. It includes, without limitation, materials that move from a first state to a second state upon application of energy, and back to the first state without application of energy.

“Transportable Recording Medium”: a relatively small medium capable of being transported by hand from one location to another. It includes, without limitation, Transportable Digital Recording Medium such as an optical disc, a floppy disk, a flash drive.

For the purpose of the rest of the disclosure, it is understood that the terms as defined above are intended, whether such terms are in all initial cap or not.

### SUMMARY OF THE INVENTION

In prior applications, Applicant disclosed the use of anti-copy and anti-theft applications. The materials may be placed in a manner to prohibit read and/or copying of the content on the recording material by altering data reads that would exist but for the application of the material to the medium. For example, state change material may be placed in a anti-theft manner to block read of content until the material is activated by an energy source to a state that allows the actual data structures associated with the material to be read as typically read by an reader. State change material may be placed on or in a recording medium, such as an optical disc, in an anti-copy manner by causing the actual data structures associated with the material to be read differently depending upon the time of read, and requiring software to detect the material to permit read and/or to detect the different data structure reads, allowing read only if the data read change is appropriately located on the medium.

Techniques for applying such materials should take into account the present conventional system of producing recording medium, such as optical recording medium.

In one embodiment, the materials, such as the dyes, are printed on the laser incident side using a printing-like process. The material, such as dye, may be printed in a conventional optical disc manufacturing process by flipping the medium onto the laser incident side, and then cross-linking the material with respect to the medium, as for example, suing an UV laser cross linking light source. Printing may reduce the time and cost to produce such medium as compared to spin coating the same which may require additional spin coating equipment to be added, for example, to conventional optical medium production lines, and may slow media production. Using printing techniques the material, such as state change material, may be applied quickly in any shape or size or configuration (such as a ring) at any desired location. Printing of the material, may be followed by hard coat application over the print, a portion of the medium on which the print is placed, or over the entire medium side on which printing occurs. The material, such as dye, may also be placed directly with the protective coating allowing printing of the material along with the protective coat in one step.

In yet another embodiment, there is disclosed a system by which a recording medium, such as an optical recording medium, can be printed with a material that prevents illicit copying and/or theft of the medium by blocking read of a portion or all of the data on the medium, by physical and/or software means as described above. Such system includes an on-line printer that prints the material in tandem with, or in subsequent application with, protectant positioned with respect to the material to reduce or prevent extraneous activation and/or degradation, and a verifier that verifies that material was accurately placed on the medium by comparing detected placement with a pre-determined position for application of the material.

In one embodiment, the printer comprises a CCD chip that is operationally configured to cause ink to be applied to the recording medium at desired locations on (or in) the medium. A light source may impinge from the non-printed side of the medium to cause activation of the protectant material placed on the print and/or the print itself.

### BRIEF DESCRIPTION OF THE DRAWINGS

Various of the above mentioned and further features and advantages will be better understood from this description of embodiments thereof, including the attached drawing figures wherein:

FIG. 1 is an illustration of an optical recording medium in which an state change material is placed over the lead in region of the medium;

FIG. 2 is an illustration of an optical recording medium in which a diameter ring of state change material is placed over the lead in region of the medium;

FIG. 3 is an graphical depiction of an optical medium on-line printer system.

### DETAILED DESCRIPTION OF THE INVENTION

One particularly useful method found by the applicant for protecting against piracy by theft and/or illicit copying has been to incorporate on the transportable recording medium a material positioned on the medium in a manner to block read of information on the medium (in whole or in part) until such material on the medium is activated by an energy source.

In another embodiment, such material is placed on the medium in a manner that it physically prevents read of one or more portion (“more portion” may include all of the medium) of the information on the medium, but upon manipulation of the material, as by way oft for example, activation, heating, erasing, of the material etc., allows read of such one or more portion of information. Such methods are particularly useful with respect to digital recording medium.

In aspects, such anti-theft/anti-copy methods may employ software and/or hardware components to detect material on the medium and to unlock information on the medium based on the detection of the material on the medium, the detection of a property associated with the material, detection of a state of the material, a change in properties of the material noted upon a first read (along one or more portions of the medium) of the medium and one or more subsequent reads (along one or more portions of the medium), or based on detecting the material at a predetermined location of such material.

As would be understood by one of skill in the art, the anti-copy methods described herein, and in other of the present inventor's patent applications can be used in conjunction with the anti-theft methods described herein, and in other of the present inventor's patent applications, on the same recording medium, such as digital recording medium. Furthermore, anti-copy methods of others may be used with anti-theft methods described herein, in other of the present inventor's applications, and anti-theft methods of others may be used with anti-copy protection methods described herein, and in other of the present inventor's applications. For example, materials in or on the medium may effectuate the anti-copy and/or anti-theft technique in conjunction with physical changes in the medium which may be used to effect anti-copy methods (for example, requiring detection of a scratch on the medium, unconventional pits and/or lands which lead to ambiguous data reads to permit read of the medium even though the material is activated to permit read).

Materials may be placed so as to prevent read of one or more portions (or all) of information on the recording medium until activated by an energy source. Materials may be placed on such medium in a manner that inhibits copying of one or more portions (or all) of information on the recording medium, either due to physical interference with the copying/read process (brought upon, in one embodiment, by the material leading to two different data outputs, such as a valid-to-valid data change, a valid-to-error data change (or vice versa), an error-to-error data change), and/or due to software/hardware requiring detection of the material and/or activated material for read of the medium (or portion thereof). Such software/hardware may be associated with the medium itself or the hardware upon which the medium is read, or associated with hardware on a processor communicating with the hardware upon which the medium is read.

In one embodiment, the material used can change physical properties upon activation with an energy source in a manner such that the chance causes a detectable change by the reader of the medium, or hardware/software communicating with the reader of the medium. The changed material may permit read by “unblocking” in its second state the block of read that existed when it was in its first state. The changed material may, in one alternative embodiment, allow read due to its second state due to software/hardware associated with the disc and/or reader which requires a detection of the second state to permit read of data on the medium. The material may be, for example, a transient, temporary or permanent state change material, which upon activation, for example by light, heat, irradiation, electromagnetic waves, etc., produces a state change in the material, for example causing the material to emit a wavelength of energy to change optical state, to shrink, to change conductivity, to emit a chemical species, etc.

In an embodiment, the transportable recording medium, such as digital recording medium, is protected against theft, or illicitly moving the digital recording medium in and out of the distribution chain, in that the medium is not readable, or fully readable, until the state-change material is activated to the state necessary for such a read. The activation may, for example, change an opaque material to a clear material allowing for laser read of the area which it covers. Or the activation may cause the material to be activated to a state that is necessary to be detected by software associated with the medium to allow read of a portion or all of the material stored on the medium. The converted state in one embodiment is a transient state that changes between one state and another state depending on activation by the read laser. The detection of the transient nature of the material may be necessary for read of the medium due to appropriately configured software associated with the medium. In another anti-theft application, the material may be a permanent state-change material such that a state-change need not be detected each time by the software in order to allow read of the medium.

In an embodiment, the transportable recording medium, such as digital recording medium, is protected against copying by, for example, including thereon a transient state change material which causes change in data read depending on which state the transient state change material happened to be. Software/hardware associated with the medium (for example, on it, communicating with the reader, etc.) may require the read of such state change in order for read to be permitted and/or to correct for the transient change in data read.

As would be understood, more than one material may be used to effect such anti-theft and/or anti-copy techniques. For example, two or more materials may be required for the anti-copy protection, each material necessary to be detected (or the effect thereof by software on the medium to unlock copy-protected material, Likewise, two or more materials may be used to effectuate an anti-theft method, such as one or more such materials causing blocking read of stored data on the disc and conversion (i.e., changing the disk from an unreadable to readable disk, in whole or in part) requiring activation of said two or more materials. Further, two or more materials may be used to effectuate an anti-theft medium wherein selective activation of each material may allow for unlocking of read with respect to different data portions of the medium. For example, activation of one material may allow for a more limited read/use of material recorded on a disc than if both materials were activated. In such embodiment, the extent of read/use may be tier priced, allowing access based on the price paid.

In one embodiment, the materials causing change include one or more dyes. When a transient state change is desired, such materials may include an electron transfer component that promotes movement of the material from its activated state back to its unactivated state. When a permanent state change, or less than a transient state change, is desired a free radical scavenger, may be employed, for example, that allows the material, such as the dye, to remain in the activated state without returning to its initial unactivated state. When dyes are employed, more than one dye may be utilized to effectuate either or both of said anti-theft/anti-copy medium, for example, a UV dye and an IR dye. The materials used may be capped with a protection solution to protect the materials from unintended activation, for example. For example, an optical media hard coat, such as Sony Chemical SK-3200, might be used to protect the materials used in the anti-theft/anti-copy methods. The material applied to the medium may be hardened or cross-linked to protect the optical medium, such as, for example, by exposing the same to a UV light source. The material may be placed by any means, as for example by spin coating onto the medium.

In one embodiment applicable to an optical digital recording medium, the material to be detected allowing read on copy-protection medium, or which prevents data read for theft-protection, is placed on the laser incident surface of the medium (alternatively it may be placed on the non-laser incident surface or anywhere in the proper of the medium as long as the material is readable by an Optical Reader for copy-protection purposes, and prevents read of a portion or all of the data on the medium for theft-protection purposes).

Application of the material, which may be a dye, for example, may be by any means.

In one embodiment, the materials, such as the dyes, are printed on the laser incident side using a printing-like process The printed material, such as dye, might then be printed after flipping the medium onto the laser incident side, and then cross-linking the material with respect to the medium, as for example, suing an UV laser cross linking light source. Printing may reduce the time and cost to produce such medium as compared to spin coating the same which may require additional spin coating equipment to be added, for example, to conventional optical medium production lines, and may slow media production. Using printing techniques the material, such as state change material, may be applied quickly in any shape or size or configuration (such as a ring) at any desired location. For example, the material may be placed in the lead area, or inner lead area, of the disc in an area as little as 2 mm to impede read, or over the entire lead area, for example in a ring (e.g., preventing an optical disc player to start playing an optical disc until the material is activated, for example bleached). Small spot areas may mean the light activator could use a focus beam, allowing for significantly shorter activation (e.g., bleach) times. In one embodiment the printing is done post production process.

Printing of the material, may be followed by hard coat application over the print, a portion of the medium on which the print is placed, or over the entire medium side on which printing occurs. The material, such as dye, may also be placed directly with the protective coating allowing printing of the material along with the protective coat in one step.

One or more of the digital data indicium associated with the state change material may be non-nominal, causing the transportable digital recording medium to be unreadable, or unreadable with respect to certain information. In an embodiment, the state change material is selected such that when the state change material is activated, the non-nominal indicia associated with the material no longer blocks the read of the digital data on the medium.

In yet another embodiment, there is disclosed a system by which a recording medium, such as an optical recording medium, can be printed with a material that prevents illicit copying and/or theft of the medium by blocking read of a portion or all of the data on the medium, by physical and/or software means as described above. Such system includes an on-line printer that prints the material in tandem with, or in subsequent application with, protectant positioned with respect to the material to reduce or prevent extraneous activation and/or degradation, and a verifier that verifies that material was accurately placed on the medium by comparing detected placement with a pre-determined position for application of the material.

In one embodiment, the printer comprises a CCD chip that is operationally configured to cause ink to be applied to the recording medium at desired locations on (or in) the medium. A light source may impinge from the non-printed side of the medium to cause activation of the protectant material placed on the print and/or the print itself.

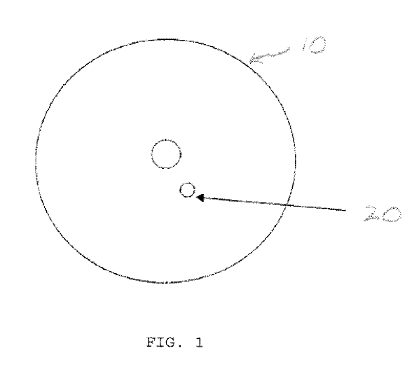

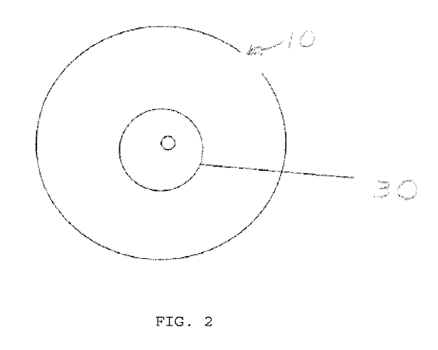

Now turning to FIG. 1, there is shown an optical recording medium 10 having a spot 20 of state change material in the lead-in region of the optical medium so as to stop play unless the material is activated to a state that no longer interferes with read of the optical medium by an optical reader. In an alternative embodiment of such optical medium, shown in FIG. 2, there is shown an optical medium 10 wherein the state change material is printed in a band or ring 30 over the lead-in region of the optical medium to cause the optical medium to be unreadable unless the state change material is activated to a state that allows read of the medium by an optical reader.

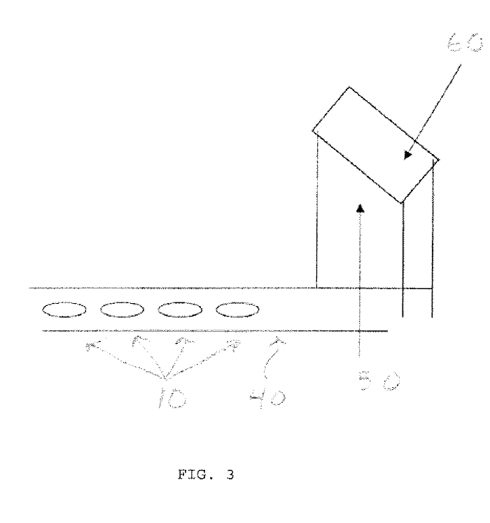

Now turning to FIG. 3, there is shown an assembly system for printing state change material onto a series of optical recording medium 10 placed on a conveyor belt 50. Printer 60 prints the optical state change material along with a protectant onto each optical recording media 10 while a UV light source causes the protectant material to harden and protect the optical state change material for activation by undesired ambient conditions.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

What is claimed is:

1. A method for producing a theft-protected optical medium:
printing onto a portion of an optical medium state change material having at least a first unactivated state and a second activated state, said portion of said optical medium and said state change material selected to cause content on said optical medium to be unreadable by an optical reader when said state change material is in an unactivated state, but to be readable by said optical reader when said state change material is in an unactivated state.

2. The method of claim 1 wherein the printing is on the laser incident side of the medium.

3. A multi-read activatable digital recording medium housing data, said medium comprising:
a first state change material capable of existing in an unactivated state and an activated state, positioned on the medium in a manner so as to inhibit read by a reader of a portion of the data recorded on the digital recording medium when in its unactivated state but not in its activated state; and
a second state change material capable of existing in an unactivated state and an activated state, positioned on the medium in a manner so as to inhibit read by a reader of a distinctly different portion of data recorded on the digital recording medium when in its unactivated state but not its activated state.

4. The medium of claim 3 wherein said state change material is a permanent state change material.

5. The medium of claim 3 wherein said state change material is a temporary state change material.

6. The medium of claim 3 wherein said state change material is a transient state change material.

7. The medium of claim 3 wherein said state change material is located in the lead-in area of the medium.

8. The medium of claim 3 wherein the state change material is in association with a free radical scavenger agent.

9. An optical recording medium production assembly system comprising:
a printer operatively configured to print optical state change material activatable from a first state to a second state with the read laser of an optical reader at pre-determined position(s) on said optical medium;
a coater electronically connected to said printer, said coater operatively configured to coat said printed optical state change material with a coating material selected to protect said optical state change material from converting form said first state to said second state due to ambient factors; and
a verifier electronically connected to said printer and said coater, said verifier positioned in said assembly and operatively configured to verify that said optical state change material is printed in said pre-determined position(s) on said optical medium and that said optical state change material is coated with said coating material from said coater.

10. The medium of claim 9 wherein said state change material is a permanent state change material.

11. The medium of claim 9 wherein said state change material is a temporary state change material.

12. The medium of claim 9 wherein said state change material is a transient state change material.

13. The medium of claim 9 wherein said state change material is located in the lead-in area of the medium.

14. The medium of claim 9 wherein the state change material is in association with a free radical scavenger agent.

15. A digital recording medium protected from read until activated, said medium comprising:
non-nominal data indicia incorporated thereon configured to interfere with read of at least one portion of said digital recording medium; and
state change material capable of existing in an unactivated and activated state in operative association with said non-nominal data in such a manner that when said state change material is in its unactivated state, said at least one portion is unreadable, but when said state change material is in its activated state, said at least one portion is readable.

16. The medium of claim 15 wherein said state change material is a permanent state change material.

16. The medium of claim 15 wherein said state change material is a temporary state change material.

17. The medium of claim 15 wherein said state change material is a transient state change material.

18. The medium of claim 15 wherein said state change material is located in the lead-in area of the medium.

19. The medium of claim 15 wherein the state change material is in association with a free radical scavenger agent.
